(19) United States
(12) Patent Application Publication
(10) Pub. No.: US 2018/0299817 A1
(43) Pub. Date: Oct. 18, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Kazufumi ISHIDA, Shimizu Sunto Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/687,081

(22) Filed: Aug. 25, 2017

(30) Foreign Application Priority Data
Apr. 14, 2017 (JP) 2017-080767

(51) Int. Cl. G03G 15/20

(52) U.S. Cl. CPC G03G 15/6529; G03G 15/50; G03G 15/20; G03G 15/16

(57) ABSTRACT

An image forming apparatus includes a toner image forming section, a transfer section, a fixing section and a guide. The toner image forming section forms a toner image on an image carrier. The transfer section transfers the toner image onto a sheet. The fixing section is arranged at a downstream side in a sheet conveyance direction with respect to the transfer section. The fixing section fixes the toner image on the sheet. The guide is arranged between the transfer section and the fixing section in the sheet conveyance direction. The guide regulates the sheet conveyance direction towards the fixing section. The downstream end of the guide in the sheet conveyance direction has a shape of being curved or inclined in a direction different from the sheet conveyance direction.

### CROSS-REFERENCE TO RELATED APPLICATION

This application is based upon and claims the benefit of priority from Japanese Patent Application No. 2017-080767, filed Apr. 14, 2017, the entire contents of which are incorporated herein by reference.

### FIELD

Embodiments described herein relate generally to an image forming apparatus.

### BACKGROUND

Conventionally, there is an image forming apparatus such as a multi-function peripheral (hereinafter, referred to as an “MFP”) and a printer. The image forming apparatus forms an image on a sheet while conveying a sheet-like image receiving medium (hereinafter, collectively referred to as a “sheet”) such as a paper.

A visible image (toner image) which is developed on a photoconductive drum by a developing device is primarily transferred onto a surface of an intermediate transfer belt contacting the photoconductive drum. The toner image primarily transferred onto the surface of the intermediate transfer belt is secondarily transferred onto the sheet by applying a transfer bias to the intermediate transfer belt. A conveyance direction of the sheet towards a fixing section is regulated by a guide arranged in the image forming apparatus. The toner image secondarily transferred onto the sheet is applied with heat and pressure by the fixing section to be fixed on the sheet.

There is a toner (decoloring toner) having a decoloring function capable of erasing a color of the toner by heating the toner to a predetermined temperature (decoloring temperature). The sheet on which the image is formed with the decoloring toner is heated to the decoloring temperature so that the toner is decolored and the sheet can be reused. The image forming apparatus can also be used to decolorize the toner on the sheet in addition to an apparatus dedicated to the decoloring. In the image forming apparatus, in order to decolorize the decoloring toner, a temperature of the fixing section is set to the decoloring temperature higher than a temperature used in a normal image forming operation. In the image forming apparatus, a conveyance route of the sheet until the fixing section is identical in both the normal image forming operation and the decoloring operation. The image forming apparatus rotates the intermediate transfer belt to convey the sheet in both the normal image forming operation and the decoloring operation.

### DESCRIPTION OF THE DRAWINGS

FIG. 1 is a schematic view illustrating an example of an internal arrangement of an image forming apparatus according to an embodiment;

FIG. 2 is a diagram illustrating an example of schematic arrangement of the image forming apparatus according to an embodiment;

FIG. 3 is a diagram illustrating an example of schematic arrangement of a fixing section according to an embodiment;

FIG. 4 is a schematic view illustrating an example of a guide according to an embodiment;

FIG. 5 is a diagram illustrating a switching control on a conveyance path of a sheet passing through the guide according to an embodiment; and

FIG. 6 is a block diagram illustrating an example of functional components of the image forming apparatus according to an embodiment.

### DETAILED DESCRIPTION

In certain image forming apparatuses, in a case of rotating the intermediate transfer belt, in order to prevent abrasion or damage of the photoconductive drum contacting the intermediate transfer belt, it is necessary to rotate the photoconductive drum as well. In a case in which motors for driving the photoconductive drum and the developing device are identical, the developing device is further rotated as well. If the photoconductive drum and the developing device are rotated, a degraded toner in the developing device due to a rotation stress is attached to the intermediate transfer belt in some cases. If the toner is attached to the intermediate transfer belt, there is a case in which the toner is transferred onto a secondary transfer roller at a timing at which there is no sheet on the intermediate transfer belt. The toner transferred onto the secondary transfer roller is attached to a back surface of the sheet in some cases. There is a case in which the toner attached to the back surface of the sheet is taken by the guide before fixing and dirt gathers in the guide. If the dirt gathers in the guide, there is a possibility that the sheet becomes dirty each time the sheet is regulated by the guide.

In accordance with an embodiment, an image forming apparatus comprises a toner image forming section, a transfer section, a fixing section and a guide. The toner image forming section forms a toner image on an image carrier. The transfer section transfers the toner image onto a sheet. The fixing section is arranged at a downstream side in a sheet conveyance direction with respect to the transfer section. The fixing section fixes the toner image on the sheet. The guide is arranged between the transfer section and the fixing section in the sheet conveyance direction. The guide regulates the sheet conveyance direction towards the fixing section. The downstream side of the guide in the sheet conveyance direction has a shape of being curved or inclined in a direction separated from the sheet conveyance direction.

Hereinafter, an image forming apparatus of an embodiment is described with reference to the accompanying drawings. Furthermore, in each diagram, the same component is given the same reference numeral.

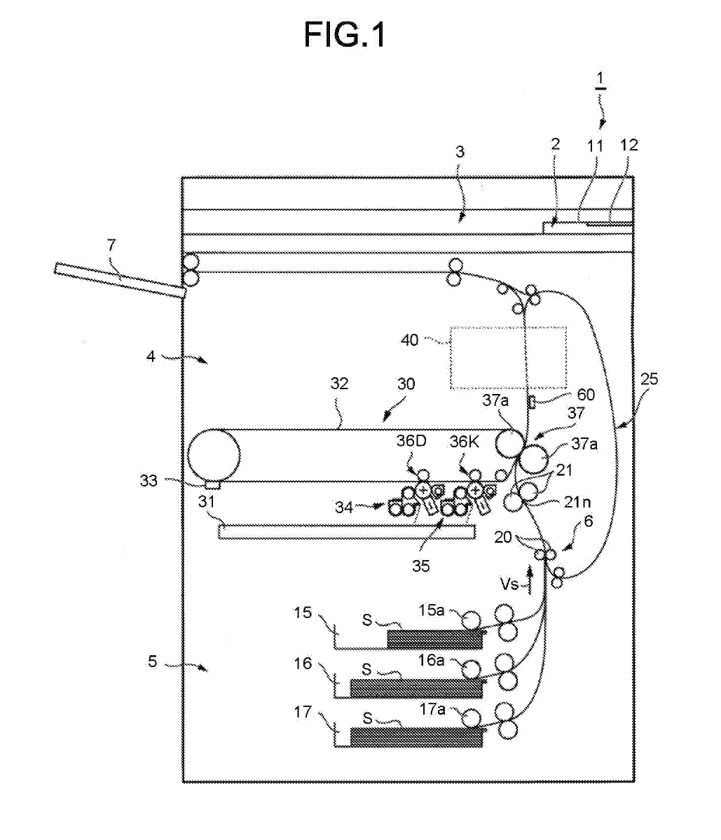

FIG. 1 is a schematic view illustrating an example of an internal construction of an image forming apparatus 1 according to an embodiment. For example, the image forming apparatus 1 is an MFP (multi-function peripheral). The image forming apparatus 1 reads an image formed on the sheet to generate digital data (image file). The image forming apparatus 1 forms an image on the sheet using a toner based on the digital data. For example, the sheet is a paper or a film. The sheet may be any material as long as the image forming apparatus 1 can form an image on the surface of the sheet.

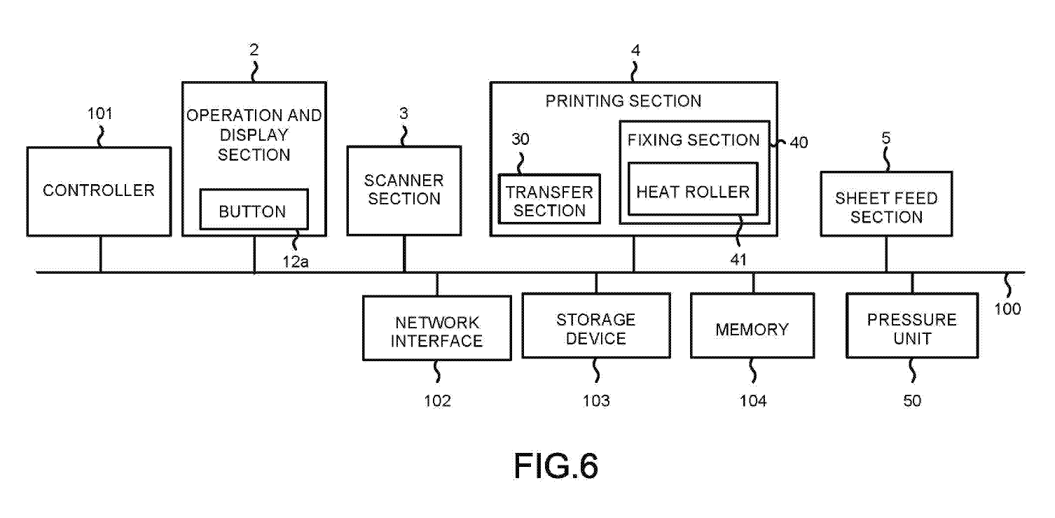

The image forming apparatus 1 includes an operation and display section 2, a scanner section 3, a printing section 4, a sheet feed section 5, a conveyance section 6, a sheet discharge section 7 and a controller 101 (refer to FIG. 6).

The operation and display section 2 is provided with a display section 11 and an operation section 12.

The display section 11 operates as an output interface to display characters and images. For example, the display section 11 maybe a display device such as a liquid crystal display and an organic EL (Electro Luminescence) display. The display section 11 displays various information on the image forming apparatus 1.

The operation section 12 operates as an input interface to receive instructions from a user. For example, the operation section 12 includes a plurality of buttons and the like. The operation section 12 receives an operation by the user on a plurality of buttons. The display section 11 and the operation section 12 may integrally form a touch panel. For example, the operation and display section 2 may be a touch panel type liquid crystal display. The operation and display section 2 may operate as an output interface and as an input interface.

The scanner section 3 reads image information of an object to be read in a scan mode. For example, the scanner section 3 may be a CIS (Contact Image Sensor), a CCD (Charge Coupled Devices) or the like. The scanner section 3 uses a sensor to read an image formed on the sheet to generate digital data.

The printing section 4 forms an image on a front surface of the sheet based on the image data generated by the scanner section 3 in a copy mode. The printing section 4 forms an image on the sheet using the toner. The printing section 4 forms an image based on image data read by the scanner section 3 or image data received from an external device. For example, the image formed on the sheet is an output image called a hard copy or a printout. Alternatively, the printing section 4 forms an image on the front surface of the sheet based on the image data received from another information processing apparatus via a network.

The sheet feed section 5 supplies the sheet used in image output to the printing section 4. The sheet feed section 5 supplies sheets one by one to the printing section 4 according to a timing at which the printing section 4 forms a toner image.

The sheet feed section 5 is provided with a plurality of sheet feed cassettes 15, 16 and 17. Each of the sheet feed cassettes 15, 16 and 17 houses a sheet having preset size and type.

The sheet feed cassettes 15, 16 and 17 have pickup rollers 15a, 16a and 17a, respectively. The pickup rollers 15a, 16a and 17a pick up the sheets one by one from the sheet feed cassettes 15, 16 and 17, respectively. The pickup rollers 15a, 16a and 17a supply the picked sheets to the conveyance section 6.

At least one of the plural sheet feed cassettes 15, 16 and 17 houses a sheet before decoloring to be fed in a decoloring mode. On the sheet before decoloring, an image is formed by a decoloring toner. The sheet before decoloring may be fed from a manual sheet feed section (not shown).

At least one of the plurality of the sheet feed cassettes 15, 16 and 17 may house a sheet on which an image forming operation using the decoloring toner is executed. For example, the sheet on which the image forming operation using the decoloring toner is executed may be a sheet of which the decoloring is completed in the decoloring mode. By executing the image forming operation with the decoloring toner again on the sheet of which the decoloring is completed, it is possible to reuse the sheet a plurality of times.

The conveyance section 6 conveys the sheet in the printing section 4 and the sheet feed section 5. In the following description, as the sheet is conveyed from the sheet feed section 5 to the sheet discharge section 7, a sheet feed section 5 side is set to an upstream side with respect to a sheet conveyance direction Vs, and a sheet discharge section 7 side is set to a downstream side with respect to the sheet conveyance direction Vs.

The conveyance section 6 includes a pair of conveyance rollers 20 and a pair of resist rollers 21.

The conveyance roller 20 conveys the sheet supplied from the pickup rollers 15a, 16a and 17a to the resist roller 21.

The resist roller 21 temporarily stops the sheet conveyed from the conveyance roller 20. The resist rollers 21 send the sheet out towards a secondary transfer section 37 in accordance with a timing at which the toner image formed on an intermediate transfer body 32 is transferred by the secondary transfer section 37. The resist rollers 21 face each other across a conveyance path between the conveyance roller 20 and the secondary transfer section 37. Between the pair of the resist rollers 21, a nip 21n is formed.

The conveyance roller 20 causes a downstream end of the sheet to abut against the nip 21n of the resist roller 21. The conveyance roller 20 aligns a position of the downstream end of the sheet by bending the sheet. The resist roller 21 conveys the sheet to the secondary transfer section 37 side after the downstream end of the sheet sent from the conveyance roller 20 is aligned at the nip 21n.

In FIG. 1, a reference numeral 25 represents an inversion unit.

The inversion unit 25 inverts the sheet discharged from a fixing section 40 by switchback. The inversion unit 25 conveys the inverted sheet to the front of the resist roller 21 again. The inversion unit 25 inverts the sheet to form a toner image on a back surface of the sheet on which a fixing processing is executed.

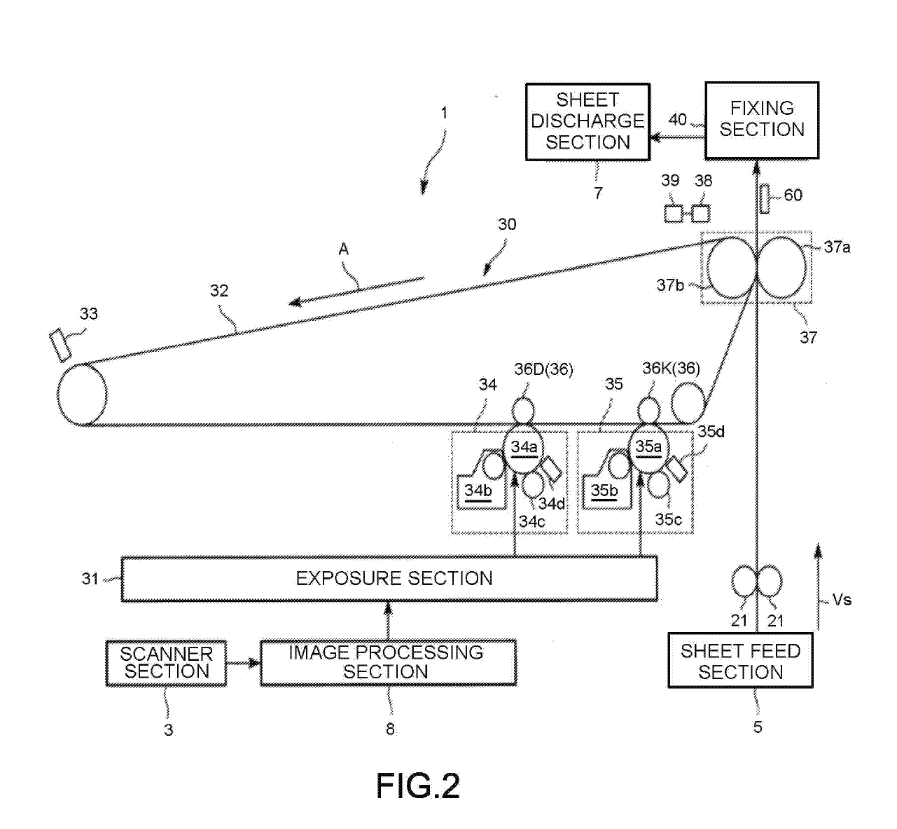

FIG. 2 is a diagram illustrating an example of schematic arrangement of the image forming apparatus 1 according to an embodiment. The image forming apparatus 1 is an image forming apparatus of an electrophotographic system. The image forming apparatus 1 may be a two-tandem type image forming apparatus.

The exemplary toner may be decoloring toner, a non-decoloring toner (normal toner), a decorative toner and the like. The decoloring toner has a property of decoloring by external stimuli. The “decoloring” refers to making an image formed with a color (including not only a chromatic color but also an achromatic color such as white and black) different from a color of a background of the sheet visually invisible. For example, the external stimulus includes temperature, light of a specific wavelength and pressure. In the present embodiment, the decoloring toner is decolorized at a prescribed decoloring temperature or more. The decoloring toner develops color at a prescribed restoring temperature or less after decoloring.

Any toner may be used as the decoloring toner as long as it has the characteristics described above. For example, a coloring agent of the decoloring toner may be a leuco dye. The decoloring toner may be appropriate combination of a developing agent, a decolorizing agent, a discoloration temperature adjusting agent and the like.

A fixing temperature of the decoloring toner is lower than a fixing temperature of the non-decoloring toner. Herein, the fixing temperature of the decoloring toner refers to a temperature of a heat roller 41 in a decoloring toner mode described later. The fixing temperature of the non-decoloring toner refers to a temperature of the heat roller 41 in a monochrome toner mode described later.

The fixing temperature of the decoloring toner is lower than a temperature of the decoloring processing of the decoloring toner. The temperature of the decoloring processing of the decoloring toner means a temperature of the heat roller 41 in the decoloring mode described later.

Next, the printing section 4 is described in detail. The printing section 4 includes a transfer unit 30 and the fixing section 40.

The transfer unit 30 is provided with an exposure section 31, the intermediate transfer body 32, a cleaning blade 33, image forming sections 34 and 35, primary transfer rollers 36D and 36K, and the secondary transfer section 37. Hereinafter, in a case of not distinguishing the primary transfer rollers, the primary transfer rollers 36D and 36K are simply described as a primary transfer roller 36.

In FIG. 2, a reference numeral 38 represents a temperature detection section, a reference numeral 39 represents a temperature adjustment section, and a reference numeral 60 represents a guide.

The temperature detection section 38 detects a temperature of the atmosphere around the secondary transfer section 37. For example, the temperature detection section 38 is a temperature sensor.

Based on a detection result of the temperature detection section 38, the temperature adjustment section 39 adjusts the temperature of the atmosphere around the secondary transfer section 37. For example, the temperature adjustment section 39 is a fan. The temperature adjustment section 39 may serve not only for adjusting the temperature of the atmosphere around the secondary transfer section 37 but also for exhausting ozone.

The guide 60 guides the sheet onto which the toner image is transferred by the secondary transfer section 37 towards the fixing section 40. The guide 60 is arranged to face the intermediate transfer body 32 across a conveyance path between the secondary transfer section 37 and the fixing section 40.

The transfer in the image forming apparatus 1 includes a first transfer process and a second transfer process.

In the first transfer process, the primary transfer roller 36 transfers images by the toner on photoconductive drums 34a and 35a of the image forming sections 34 and 35 onto the intermediate transfer body 32.

In the second transfer process, the secondary transfer section 37 transfers images by the toner laminated on the intermediate transfer body 32 onto the sheet.

The scanner section 3 reads the image formed on the sheet which is a scanning object. For example, the scanner section 3 reads the image on the sheet to generate the image data. The scanner section 3 outputs the generated image data to an image processing section 8.

The image processing section 8 controls the exposure section 31 based on a color signal of the image data output from the scanner section 3.

The exposure section 31 irradiates (via exposure) the photoconductive drums 34a and 35a of the image forming sections 34 and 35 with light. The exposure section 31 includes an exposure light source such as a laser and an LED.

The intermediate transfer body 32 is an endless belt. The intermediate transfer body 32 (hereinafter, also referred to as an “intermediate transfer belt 32”) rotates in an arrow A direction in FIG. 2. The toner image is formed on the surface of the intermediate transfer belt 32.

The cleaning blade 33 removes the toner adhering to the intermediate transfer belt 32. For example, the cleaning blade 33 is a plate-like member. For example, the cleaning blade 33 is made of resin such as urethane resin. For example, a tip of the cleaning blade 33 is pressed against the intermediate transfer belt 32, and the toner on the intermediate transfer belt 32 is scraped off. Instead of the cleaning blade 33, a charged brush may contact the intermediate transfer belt 32.

The image forming sections 34 and 35 form an image with toner of each color (2 colors in an example shown in FIG. 2). The image forming sections 34 and 35 are arranged in order along the intermediate transfer belt 32.

The primary transfer roller 36 is used at the time of transferring the toner image formed by the image forming sections 34 and 35 onto the intermediate transfer belt 32.

The secondary transfer section 37 includes a secondary transfer roller 37a and a secondary transfer counter roller 37b. The secondary transfer section 37 transfers the toner image formed on the intermediate transfer belt 32 onto the sheet. The controller 101 (refer to FIG. 6) can control a rotation speed of the secondary transfer roller 37a.

In the secondary transfer section 37, the intermediate transfer belt 32 contacts the secondary transfer roller 37a. In terms of improving a paper jam, the intermediate transfer belt 32 and the secondary transfer roller 37a may be capable of separating from each other.

The fixing section 40 fixes the toner image by applying heating and pressure to the toner image transferred onto the sheet on the sheet. The sheet on which the image is fixed by the fixing section 40 is discharged from the sheet discharge section 7 to the outside of the apparatus.

Next, the image forming sections 34 and 35 are described.

The image forming section 34 transfers a decoloring toner image formed by the decoloring toner having a decoloring function onto the intermediate transfer belt 32. The image forming section 34 (hereinafter, also referred to as a “decoloring image forming section 34”) houses the decoloring toner.

The image forming section 35 is arranged at the downstream side with respect to the decoloring image forming section 34 in the rotation direction A of the intermediate transfer belt 32. The image forming section 35 transfers a non-decoloring toner image formed by the non-decoloring toner that does not have the decoloring function onto the intermediate transfer belt 32. In an embodiment, the image forming section 35 (hereinafter, also referred to as a “non-decoloring image forming section 35”) houses a non-decoloring black toner.

The decoloring image forming section 34 and the non-decoloring image forming section 35 have the same or similar construction although the toner housed therein is different. Thus, the decoloring image forming section 34 is described on behalf of the image forming sections 34 and 35, and the description of the non-decoloring image forming section 35 is omitted.

The decoloring image forming section 34 includes the photoconductive drum 34a, a developing device 34b, a charging device 34c and a cleaning blade 34d.

The photoconductive drum 34a is a concrete example of an image carrier (image carrying module). The photoconductive drum 34a has a photoreceptor (photoconductive area) on an outer peripheral surface thereof. For example, the photoreceptor is an organic photoconductor (OPC). In the decoloring image forming section 34, the intermediate transfer belt 32 and the photoconductive drum 34a contact each other.

The developing device 34 b houses the developing agent. The developing agent contains the toner. The developing device 34b causes the toner to adhere to the photoconductive drum 34a. For example, the toner may be used as a one-component developing agent or as a two-component developing agent in combination with a carrier. For example, an iron powder or a polymer ferrite particle having a particle diameter of several tens μm is used as the carrier. In an embodiment, a two-component developing agent containing a non-magnetic toner is used.

The charging device 34 cuniformly charges the surface of the photoconductive drum 34a.

The cleaning blade 34d removes the toner attached to the photoconductive drum 34a.

The outline of the operation of the decoloring image forming section 34 is described.

The photoconductive drum 34a is charged to a predetermined potential by the charging device 34c. Next, the light is emitted from the exposure section 31 to the photoconductive drum 34a. Then, the potential of a region irradiated with the light in the photoconductive drum 34a changes. Due to the change in potential, an electrostatic latent image is formed on the surface of the photoconductive drum 34a. The electrostatic latent image on the surface of the photoconductive drum 34a is developed by the developing agent in the developing device 34b. On the surface of the photoconductive drum 34a, an image developed by the toner (hereinafter referred to as a “developed image”) is formed. In the decoloring image forming section 34, the developing device 34b and the charging device 34c function as a decoloring toner image forming section for forming the decoloring toner image on the photoconductive drum 34a which is the image carrier.

The developed image formed on the surface of the photoconductive drum 34a is transferred onto the intermediate transfer belt 32 by the primary transfer roller 36D facing the photoconductive drum 34a (first transfer process).

By the operation of the decoloring image forming section 34, an image only using the decoloring toner is formed. In other words, by the operation of the decoloring image forming section 34, the developed image only using the decoloring toner is formed on the intermediate transfer belt 32.

On the other hand, if the non-decoloring image forming section 35 operates, the developed image only using the non-decoloring toner is formed on the intermediate transfer belt 32. In other words, by the operation of the non-decoloring image forming section 35, the developed image only using the non-decoloring toner is formed on the intermediate transfer belt 32. In the non-decoloring image forming section 35 shown in FIG. 2, a reference numeral 35a represents a photoconductive drum, a reference numeral 35b represents a developing device, a reference numeral 35c represents a charging device, and a reference numeral 35d represents a cleaning blade. In the non-decoloring image forming section 35, the developing device 35b and the charging device 35c function as a non-decoloring toner image forming section for forming a non-decoloring toner image on the photoconductive drum 35a which is an image carrier. The non-decoloring toner image forming section is contained in a toner image forming section. Hereinafter, the decoloring toner image forming section and the non-decoloring toner image forming section are collectively called a “toner image forming section” in some cases.

In the non-decoloring image forming section 35, the intermediate transfer belt 32 contacts the photoconductive drum 35a. The non-decoloring image forming section 35 is arranged at the downstream side with respect to the decoloring image forming section 34 in the rotation direction A of the intermediate transfer belt 32, and in this way, the photoconductive drum 35a and the developing device 35b in the non-decoloring image forming section 35 at the downstream side rotate even in the decoloring operation. The photoconductive drum 35a and the developing device 35b are driven by the same motor.

The second transfer process is described.

A voltage (bias) is applied to the secondary transfer counter roller 37b. Thus, an electric field is generated between the secondary transfer counter roller 37b and the secondary transfer roller 37a. Since it is a necessary condition that an electric field is generated between the secondary transfer counter roller 37b and the secondary transfer roller 37a, the voltage (bias) may be applied to the secondary transfer roller 37a.

By the electric field generated between the secondary transfer counter roller 37b and the secondary transfer roller 37a, the secondary transfer section 37 transfers the developed image formed on the intermediate transfer belt 32 onto the sheet. The sheet onto which the developed image is transferred is guided by the guide 60 towards the fixing section 40.

The fixing section 40 is described.

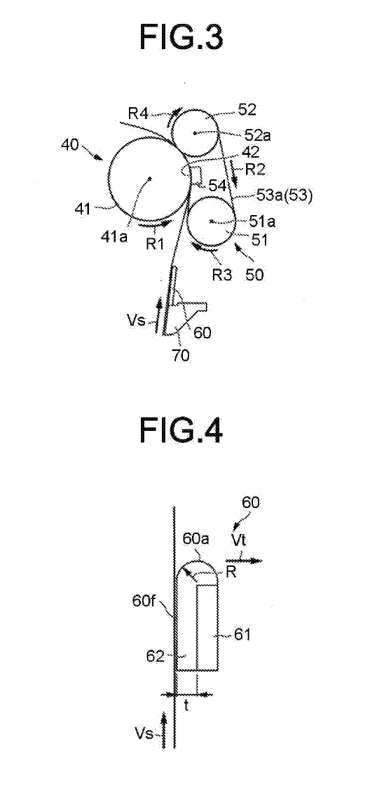

FIG. 3 is a diagram illustrating an example of schematic arrangement of the fixing section 40 according to an embodiment.

As shown in FIG. 3, the fixing section 40 includes a heat roller 41 (heating section) and a pressure unit 50.

The heat roller 41 (rotating body) which is a heating unit is described.

The heat roller 41 is arranged at the downstream side with respect to the secondary transfer section 37 (refer to FIG. 2) in the sheet conveyance direction Vs. The heat roller 41 is driven at two target temperatures described later. The heat roller 41 is an endless fixing member. The heat roller 41 has a curved outer peripheral surface. The heat roller 41 has a cylindrical shape. The heat roller 41 is a metal roller. For example, the heat roller 41 has a resin layer of fluororesin or the like on an outer peripheral surface of an aluminum roller. The heat roller 41 is rotatable around a first axis 41a. The first axis 41a means a center axis (rotation axis) of the heat roller 41.

The fixing section 40 further includes a heat source (not shown) for heating the heat roller 41. For example, the heat source may be a resistance heat generation element such as a thermal head, a ceramic heater, a halogen lamp, an electromagnetic induction heating unit, or the like. The heat source may be arranged at the inside or outside of the heat roller 41.

The pressure unit 50 is described.

The pressure unit 50 includes a plurality of rollers 51 and 52, a belt 53 (rotating body) and a pressure pad 54 (pressure member).

The plurality of rollers 51 and 52 is arranged at the inside of the belt 53. In the present embodiment, the plurality of rollers 51 and 52 include a first roller 51 and a second roller 52. Furthermore, the plurality of rollers 51 and 52 may be the same roller or may be different rollers.

The plurality of rollers 51 and 52 is rotatable around a plurality of rotation axes 51a and 52a in parallel with the first axis 41a. The plurality of rollers 51 and 52 is arranged at a position contributing to formation of a nip 42.

The first roller 51 is arranged at the upstream side with respect to the second roller 52 in the sheet conveyance direction Vs. The first roller 51 has a cylindrical shape. For example, the first roller 51 is made of metal such as iron. The first roller 51 is rotatable around the first rotation axis 51a parallel to the first axis 41a. The first rotation axis 51a means a central axis of the first roller 51.

The second roller 52 is arranged at the downstream side with respect to the first roller 51 in the sheet conveyance direction Vs. The second roller 52 has a cylindrical shape. For example, the second roller 52 is made of metal such as iron. The second roller 52 is rotatable around the second rotation axis 52a parallel to the first axis 41a. The second rotation axis 52a means a central axis of the second roller 52.

The belt 53 faces the heat roller 41. The belt 53 is stretched over the first roller 51 and the second roller 52. The belt 53 is formed into an endless shape.

The belt 53 includes a base layer 53 a and a release layer (not shown). For example, the base layer 53 a is formed of a polyimide resin (PI). For example, the release layer is formed by a fluororesin such as tetrafluoroethylene perfluoroalkyl vinyl ether copolymer resin (PFA). The layer structure of the belt 53 is not limited. The belt 53 includes a film-like member.

The pressure pad 54 has a rectangular parallelepiped shape. For example, the pressure pad 54 is formed of a resin material such as heat-resistant PPS (polyphenylene sulfide resin), LCP (liquid crystal polymer), PF (phenol resin) or the like. The pressure pad 54 is arranged at a position opposed to the heat roller 41 across the belt 53. The pressure pad 54 is energized toward the heat roller 41 by an energization member (not shown) such as a spring. The pressure pad 54 abuts against the inner peripheral surface of the belt 53 and pushes the belt 53 against the heat roller 41 to form the nip 42. The pressure pad 54 presses the inner peripheral surface of the belt 53 against the heat roller 41 side to form the nip 42 between the belt 53 and the heat roller 41.

A rotation direction of the heat roller 41 is described.

The heat roller 41 rotates in an arrow R1 direction by a motor (not shown). The heat roller 41 rotates in the arrow R1 direction independent of the pressure unit 50. In an embodiment, the heat roller 41 is a drive roller.

The belt 53 is driven by the heat roller 41 to rotate in an arrow R2 direction. The belt 53 is driven to rotate by abutting against an outer peripheral surface of the heat roller 41 rotating in the arrow R1 direction.

The first roller 51 is driven by the belt 53 to rotate in an arrow R3 direction. The second roller 52 is driven by the belt 53 to rotate in an arrow R4 direction. The first roller 51 and the second roller 52 are driven to rotate by abutting against the inner peripheral surface of the belt 53 rotating in the arrow R2 direction.

The heat roller 41 and the belt 53 correspond to “a pair of rotating bodies” described in the claim. The controller 101 (refer to FIG. 6) can control a rotation speed of the heat roller 41. By controlling the rotation speed of the heat roller 41, it is possible to control the rotation speeds of the heat roller 41 and the belt 53.

Next, a type of an image forming processing executed by the image forming apparatus 1 (refer to FIG. 1) of an embodiment is described. The image forming apparatus 1 executes a printing in two modes shown below.

monochrome toner mode: forming an image with non-decoloring black toner.

decoloring toner mode: forming an image only with the decoloring toner.

Which mode is used to execute the image forming operation can be selected by a user operating the operation and display section 2 (refer to FIG. 1) of the image forming apparatus 1.

In the monochrome toner mode, the non-decoloring image forming section 35 (refer to FIG. 2) using the non-decoloring black (K) toner operates to form an image. The monochrome toner mode is selected if the user desires to print a general monochrome image. For example, the monochrome toner mode is used in a case of keeping important data and the like without reusing the paper.

In the decoloring toner mode, only the decoloring image forming section 34 (refer to FIG. 2) using the decoloring toner operates to form an image. The decoloring toner mode is selected in a case of reusing a paper on which the image is formed.

The fixing section 40 is controlled in the fixing mode and the decoloring mode. In the fixing mode, the toner image is fixed on the sheet. In the decoloring mode, the toner image is decolorized from the sheet. In the decoloring mode, the temperature of the heat roller 41 is higher than that in the fixing mode. The controller 101 (refer to FIG. 6) operates the fixing section 40 in at least two target temperatures. Specifically, two target temperatures of the fixing section 40 are stored in a memory 104 described later. The controller 101 extracts the target temperature from the memory 104 in response to the selected mode to operate the fixing section 40. The two target temperatures include a first temperature and a second temperature. The first temperature is a temperature at the time of the decoloring mode. The second temperature is a temperature at the time of the fixing mode. The second temperature is lower than the first temperature. As the number of times of reuse of the sheet is increased, a coating layer of the decoloring toner on the sheet becomes thick, so rigidity of the sheet tends to increase, and the sheet conveyance direction is strongly influenced by regulation by the guide 60. The operation and display section 2 shown in FIG. 1 includes a button 12a (refer to FIG. 6, the operation section 12) for switching the fixing section 40 from the decoloring mode to the fixing mode.

The guide 60 is described.

As shown in FIG. 2, the guide 60 is arranged between the secondary transfer section 37 and the fixing section 40 in the sheet conveyance direction Vs. The guide 60 regulates the conveyance of the sheet at the upstream side of the fixing section 40 in the sheet conveyance direction Vs. The guide 60 regulates the sheet conveyance direction towards the fixing section 40.

In FIG. 3, a reference numeral 70 represents a conveyance path forming section for forming a conveyance path of the sheet. As shown in FIG. 3, the guide 60 is fixed in the conveyance path forming section 70. The guide 60 is fixed at a fixed position. A downstream end of the guide 60 in the sheet conveyance direction Vs (hereinafter, also referred to as a “downstream end of the guide 60”) directs to the nip 42.

FIG. 4 is a schematic view illustrating the guide 60 according to an embodiment.

As shown in FIG. 4, the downstream end of the guide 60 is curved in a direction separated from the sheet conveyance direction Vs. In other words, at the downstream end of the guide 60, a curved section 60a curved to be positioned in a direction Vt against a back surface side of the sheet is arranged at the downstream side of the sheet conveyance direction Vs.

The back surface of the sheet is a surface opposite to a surface (front surface) of the sheet onto which the toner image is transferred. The direction Vt against the back surface side of the sheet is a direction opposite to a surface of the sheet (front surface) onto which the toner image is transferred. The direction Vt against the back surface side of the sheet is a direction separated from the sheet at an opposite side of the intermediate transfer belt 32 across the conveyance path between the secondary transfer section 37 and the fixing section 40 shown in FIG. 2.

The guide 60 has a sheet contact surface 60f in contact with the sheet. The sheet contact surface 60f is a plane facing the back surface of the sheet. The sheet is conveyed along the sheet contact surface 60f. In the guide 60, the sheet contact surface 60f and the outer surface of the curved section 60a are smoothly connected. If viewed in a direction parallel to the first axis 41a (refer to FIG. 3), the curved section 60a of the guide 60 forms an arc shape that is convex towards the nip. The direction parallel to the first axis 41a corresponds to a sheet width direction orthogonal to the sheet conveyance direction Vs. In an embodiment, a curvature radius R of the curved section 60a is about 2 mm. The downstream end of the guide 60 has an arc shape with the curvature radius of about 2 mm.

At least a part of the guide 60 that contacts the sheet is made of resin. In an embodiment, the guide 60 is formed by covering a sheet metal 61 (plate-like metal member) with a resin member 62.

The sheet metal 61 has a rectangular plate shape. For example, the sheet metal 61 is formed by plastically working a metal plate at room temperature. The sheet contact surface 60f side of the sheet metal 61 and the downstream side of the sheet conveyance direction Vs are covered with a resin member 62. On the other hand, the side opposite to the sheet contact surface 60f side of the metal plate 61 is exposed from the resin member 62. While the sheet is conveyed towards the fixing section 40 (refer to FIG. 3), the sheet does not contact with the sheet metal 61.

In an embodiment, a thickness t of the resin member 62 is about 2 mm. The thickness t of the resin member 62 is the thickness of a portion of the resin member 62 covering the sheet contact surface 60f side of the metal plate 61. The thickness t of the resin member 62 is a length of the resin member 62 in the direction orthogonal to the sheet contact surface 60f if viewed in the direction (sheet width direction) parallel to the first axis 41a (refer to FIG. 3). The thickness t of the resin member 62 is substantially the same as the thickness of the metal plate 61.

A switching control of the conveyance path of the sheet passing through the guide 60 is described.

The controller 101 (refer to FIG. 6) can switch the conveyance path of the sheet passing through the guide 60. The controller 101 controls the rotation speed of the heat roller 41 in such a manner that the sheet passing through the guide 60 is deviated in a direction Vt (hereinafter, also referred to as a “sheet back surface direction Vt”) against the back surface side of the sheet from the sheet contact surface 60f.

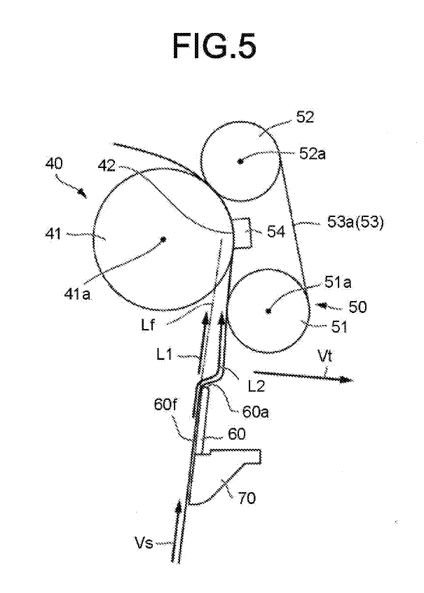

FIG. 5 is a diagram illustrating the switching control of the conveyance path of the sheet passing through the guide 60.

As shown in FIG. 5, at the downstream side with respect to the guide 60 in the sheet conveyance direction Vs, a plurality of conveyance paths L1 and L2 are formed. In an embodiment, two conveyance paths L1 and L2 are formed at the downstream side with respect to the guide 60 in the sheet conveyance direction Vs.

Hereinafter, a conveyance path L1 in which the sheet passing through the guide 60 linearly moves towards the nip 42 is referred to as a “first conveyance path L1”, and the conveyance path L2 in which the sheet passing through the guide 60 moves towards the nip 42 after shifting in the sheet back surface direction Vt is referred to as a “second conveyance path L2”.

In FIG. 5,a virtual straight line Lf which is a straight line heading from the downstream end of the sheet contact surface 60f to the nip 42 is set. The virtual straight line Lf is a straight line obtained by extending the sheet contact surface 60f if seen from a direction (sheet width direction) parallel to the first axis 41a (refer to FIG. 3). The first conveyance path L1 is a conveyance path along the virtual straight line Lf. The second conveyance path L2 curves toward the nip 42 after deviating to the sheet back surface direction Vt rather than the virtual straight line Lf.

The controller 101 switches the sheet passing through the guide 60 to pass through the first conveyance path L1 or the second conveyance path L2 by controlling the rotation speed of the heat roller 41. For example, the controller 101 controls the rotation speed of the heat roller 41 so that the speed at which the sheet passes through the nip 42 is slower than the speed at which the sheet is conveyed from the secondary transfer section 37 to the nip 42. For example, the controller 101 changes the speed at which the sheet passes through the nip 42 depending on the type of the sheet or the type of the toner. The controller 101 may detect the state of the sheet and change the speed at which the sheet passes through the nip 42 depending on the detected state of the sheet. The timing to change the speed at which the sheet passes through the nip 42 is, for example, a timing to switch a plain paper to a reusable paper with higher rigidity than the plain paper. For example, the reusable paper is frequently used at the time of decoloring and fixing, and the rotation speed of the heat roller 41 is slower than that of the heat roller 41 at the time of the monochrome toner mode. On the other hand, the speed at which the sheet is conveyed from the secondary transfer section 37 to the nip 42 is constant regardless of the mode. If the speed at which the sheet passes through the nip 42 is lower than the speed at which the sheet is conveyed from the secondary transfer section 37 to the nip 42, there is a difference in the conveyance speed of the sheet between the secondary transfer section 37 and the nip 42. If a difference is generated in the conveyance speed of the sheet between the secondary transfer section 37 and the nip 42, the sheet is inserted in the nip 42 in a state of being bent in the direction separated from a sheet guiding direction of the guide 60 (the sheet back surface direction Vt). The timing of changing the speed at which the sheet passes through the nip 42 is not limited to the timing of switching to the reusable paper but may be a timing to switch the plain paper to a thick paper having higher rigidity than the plain paper.

In the monochrome toner mode, by making the rotation speed of the heat roller 41 substantially the same as the rotation speed of the secondary transfer roller 37a (refer to FIG. 2), the controller 101 permits the sheet passing through guide 60 to pass through the first conveyance path L1.

On the other hand, the controller 101 permits the sheet passing through the guide 60 to pass through the second conveyance path L2 by making the rotation speed of the heat roller 41 slower than the rotation speed of the secondary transfer roller 37a. By enabling the sheet passing through the guide 60 to pass through the second conveyance path L2, as the sheet bends along the second conveyance path L2, a force stored in the sheet can be released. Since the sheet bends along the second conveyance path L2, the force can be released if the load causing the wrinkle is added to the sheet. Therefore, it is possible to prevent wrinkles from occurring in the sheet.

The functional components of the image forming apparatus 1 are described.

FIG. 6 is a block diagram illustrating an example of functional components of the image forming apparatus 1 according to an embodiment.

As shown in FIG. 6, functional sections of the image forming apparatus 1 are connected to each other via a system bus line 100 in a data communicable manner.

The controller 101 controls the operation of each functional section of the image forming apparatus 1. The controller 101 executes various processing by executing a program. The controller 101 acquires an instruction input by the user from the operation and display section 2. The controller 101 executes a control processing based on the acquired instruction.

A network interface 102 transmits and receives data to and from other devices. The network interface 102 operates as an input interface to receive the data transmitted from other devices. The network interface 102 also operates as an output interface to transmit the data to other devices.

A storage device 103 stores various data. For example, the storage device 103 is a hard disk or an SSD (Solid State Drive). For example, various data include digital data, screen data of a setting screen, setting information, a job, a job log and the like. The digital data is generated by the scanner section 3. The setting screen is a screen for setting the switching of the conveyance paths L1 and L2 (refer to FIG. 5). The setting information relates to the setting operation of switching of the conveyance paths L1 and L2 (refer to FIG. 5).

A memory 104 temporarily stores data used by each functional section. For example, the memory 104 is a RAM (Random Access Memory). For example, the memory 104 temporarily stores the digital data, the job, the job log and the like.

By the way, in a case of rotating the intermediate transfer belt, in order to prevent the abrasion or damage of the photoconductive drum in contact with the intermediate transfer belt, it is necessary to rotate the photoconductive drum as well. If the motors driving the photoconductive drum and the developing device are the same, the developing device is also rotated. If the photoconductive drum and the developing device rotate, the degraded toner in the developing device due to rotation stress adheres to the intermediate transfer belt. If the toner adheres to the intermediate transfer belt, the toner is transferred to the secondary transfer roller at the timing at which there is no sheet on the intermediate transfer belt. The toner transferred to the secondary transfer roller may adhere to the back surface of the sheet. The toner adhering to the back surface of the sheet is scraped by the guide before fixing and dirt may gather in the guide. If the dirt gathers in the guide, there is a possibility that the sheet becomes dirty every time the sheet is regulated by the guide.

Furthermore, if the downstream end of the guide is not a curved shape but a linearly inclined shape, the guide becomes a sharp guide shape, and the toner attached to the back surface of the sheet is easy to scrape at a pointed portion of the guide. Therefore, the downstream end of the guide is preferably curved rather than the inclined shape. In addition, because the sheet contacts the guide, by friction between the sheet and the guide, the guide may become charged. If the guide is charged to an opposite polarity to the toner, the guide plays a role of attracting the toner on the intermediate transfer belt, and the toner may adhere to the guide. In addition, if the guide is conducted to the ground, a potential difference between the guide and the intermediate transfer belt increases, and toner may stick to the guide. In addition, the toner before fixing on the sheet is affected by the guide conducted to the ground.

According to an embodiment, the image forming apparatus has the toner image forming section, the secondary transfer section 37, the fixing section 40 and the guide 60. The toner image forming section forms the toner image on the photoconductive drum which is the image carrier. The secondary transfer section 37 transfers the toner image to the sheet. The fixing section 40 is arranged at the downstream side of the secondary transfer section 37 in the sheet conveyance direction Vs. The fixing section 40 fixes the toner image on the sheet. The guide 60 is arranged between the secondary transfer section 37 and the fixing section 40 in the sheet conveyance direction Vs. The guide 60 regulates the sheet conveyance direction to the fixing section 40. The downstream end of the guide 60 is curved in a direction separated from the sheet conveyance direction Vs. With the above construction, the following effects are obtained. Even if the toner adheres to the back surface of the sheet, it is possible to prevent dirt from gathering in the guide 60 because the toner is not scraped in the curved section 60a of the downstream end of the guide 60. Since the dirt does not gather the guide 60, it is possible to prevent the sheet from being contaminated every time the sheet is regulated by the guide 60. Therefore, contamination of the sheet due to the toner can be prevented.

The fixing section 40 includes the heat roller 41 and the belt 53 forming the nip 42. The image forming apparatus 1 further includes the controller 101 for controlling the rotation speed of the heat roller 41 so that the speed at which the sheet passes through the nip 42 is slower than the speed at which the sheet is conveyed from the secondary transfer section 37 to the nip 42. With the above construction, the following effects are obtained. A difference occurs in the conveyance speed of the sheet between the secondary transfer section 37 and the nip 42 in the case in which the speed at which the sheet passes through the nip 42 is lower than the speed at which the sheet is conveyed from the secondary transfer section 37 to the nip 42. If the difference is generated in the conveyance speed of the sheet between the secondary transfer section 37 and the nip 42, the sheet is inserted in the nip 42 in a state of bending in a direction (i.e., sheet back surface direction Vt) separated from the sheet guiding direction of the guide 60. If the sheet passing through the guide 60 is deviated in the sheet back surface direction Vt with respect to the sheet contact surface 60f, the sheet bends so that the force can be released if the load causing the wrinkle is applied to the sheet. Therefore, it is possible to prevent wrinkles from occurring in the sheet.

The non-decoloring image forming section 35 has the following effect by being arranged at the downstream side of the decoloring image forming section 34 in the rotation direction A of the intermediate transfer belt 32. If the non-decoloring image forming section 35 is located at the downstream side of the decoloring image forming section 34 in the rotation direction A of the intermediate transfer belt 32, even during the decoloring operation, the photoconductive drum 35a and the developing device 35b in the non-decoloring image forming section 35 at the downstream side are rotated. While the intermediate transfer belt 32 rotates, if the photoconductive drum 35a is stationary, there is a possibility of damaging the photoconductive drum 35a. If the photoconductive drum 35a and the developing device 35b in the non-decoloring image forming section 35 are rotated, the non-decoloring toner degraded by rotation stress may adhere to the intermediate transfer belt 32. If the non-decoloring toner adheres to the intermediate transfer belt 32, the non-decoloring toner may be transferred to the secondary transfer roller 37a at the timing at which there is no sheet on the intermediate transfer belt 32. The non-decoloring toner transferred to the secondary transfer roller 37a may adhere to the back surface of the sheet. If the non-decoloring toner adheres to the back surface of the sheet, the non-decoloring toner scratches the guide, so that the dirt gathers in the guide and the sheets possibly gets dirty every time the sheet is regulated by the guide. According to an embodiment, the curved section 60a is provided at the downstream end of the guide 60, and in this way, even if the non-decoloring toner adheres to the back surface of the sheet, since the toner is not scraped in the curved section 60a of the downstream end of the guide 60, it is possible to prevent the guide 60 from accumulating the dirt. Therefore, even if the non-decoloring image forming section 35 is located at the downstream side of the decoloring image forming section 34 in the rotation direction A of the intermediate transfer belt 32, it is possible to prevent the sheet from getting dirty by the toner. According to an embodiment, even in the case in which the non-decoloring toner is black, it is preferable because it can prevent contamination of the sheet due to the toner.

As a result of earnest study, it is found that the sheet subjected to the decoloring processing one or more times is more likely to attach the toner as compared with the sheet on which the decoloring processing is not performed. According to the findings of the present inventor, the following reasons are considered. As the number of times of the reuse increases, the coating layer of the non-decoloring toner on the sheet becomes thicker, it is believed that the smoothness of the surface of the sheet improves and the toner transfer efficiency increases. According to an embodiment, by arranging the curved section 60a at the downstream end of the guide 60, even if the sheet conveyance direction on which the decoloring processing is performed one or more times is regulated by the guide 60, since the toner is not scraped in the curved section 60a of the downstream end of the guide 60, the dirt can be prevented from gathering in the guide 60. Therefore, even if the number of times of the reuse increases, contamination of the sheet due to the toner can be prevented.

At least the part of the guide 60 that contacts the sheet is made of resin, and thus the following effects are obtained. If the guide is only made of sheet metal (if grounded to earth), the charge deposited on the sheet is disturbed and the force to hold the toner on the sheet becomes weak, and thus the dirt is more likely to gather and there is a possibility that the sheet gets dirty every time the sheet is regulated by the guide. According to an embodiment, since at least the part of the guide 60 contacting the sheet is formed of an insulating resin, it is possible to prevent the dirt from gathering in the guide 60. Therefore, contamination of the sheet due to the toner can be effectively prevented as compared with a case in which the guide is formed only by the sheet metal.

Since the guide 60 is formed by covering the sheet metal 61 with the resin member 62, the following effect is achieved. The rigidity of the guide 60 can be secured by the sheet metal 61 and the positional accuracy of the guide 60 can be secured.

Since a thickness t of the resin member 62 is 2 mm, contamination of the sheet due to the toner can be effectively prevented. The thickness t of the resin member 62 is preferably equal to or greater than 2 mm and equal to or smaller than 5 mm. If the thickness t of the resin member 62 is less than 2 mm, the insulating part is too thin, and there is a possibility that it becomes difficult to prevent contamination of the sheet due to the toner.

The curvature radius R of the curved section 60a is 1 mm, and thus it is possible to effectively prevent contamination of the sheet due to the toner. The curvature radius R of the curved section 60a is preferably equal to or greater than 1 mm and equal to or smaller than 4 mm. It is preferable that the downstream end of the guide 60 has an arc shape with a curvature radius R equal to or greater than 1 mm and equal to or smaller than 4 mm. If the curvature radius R of the curved section 60a is less than 1 mm, the degree of curvature of the curved section 60a is too small, and if the toner adheres to the back surface of the sheet, there is a possibility that the toner is scraped at the downstream end of the guide 60, the dirt gathers and it is difficult to prevent the contamination of the sheet by the toner. On the other hand, if the curvature radius R of the curved section 60a exceeds 4 mm, the degree of curvature of the curved section 60a becomes too large, and there is a possibility that the sheet conveyance becomes unstable.

Experimental results confirmed the influence of the number of times of the reuse of the sheet, the thickness t of the resin member 62 (hereinafter, also referred to as a “resin thickness t”) and the curvature radius R of the curved section 60a (hereinafter, also referred to as a “curved part R”) on the contamination on the back surface of the sheet.

TABLE 1

| | RESIN | CURVED | CONTAMINATION (LV) | | | | | |
|---|---|---|---|---|---|---|---|---|
| | THICKNESS | PART | NUMBER OF TIMES OF REUSE (TIMES) | | | | | |
| | t(mm) | R(mm) | 0 | 1 | 2 | 3 | 4 | 5 |
| FIRST | 1.5 | 0 | LV1 | LV1 | LV1 | LV2 | LV2 | LV2.5 |
| CONVEYANCE | 1.5 | 1 | LV0 | LV1 | LV1 | LV2 | LV2 | LV2.5 |
| PATH L1 | 1.5 | 1.5 | LV0 | LV1 | LV1 | LV2 | LV2 | LV2.5 |
| | 1.5 | 2 | LV0 | LV0 | LV0 | LV1 | LV1 | LV2 |
| SECOND | 1.5 | 0 | LV1 | LV4 | — | — | — | — |
| CONVEYANCE | 0 | 0 | LV2 | LV5 | — | — | — | — |
| PATH L2 | 0 | 1 | LV1.5 | LV2 | LV2.5 | LV2.5 | LV3 | LV3 |
| | 2 | 0 | LV1 | LV3.5 | — | — | — | — |
| | 2 | 1 | LV0 | LV1 | LV1 | LV1.5 | LV2 | LV2.5 |
| | 2 | 1.5 | LV0 | LV0 | LV0 | LV1 | LV1.5 | LV2 |
| | 2 | 2 | LV0 | LV0 | LV0 | LV1 | LV1.5 | LV2 |

Table 1 shows the relationship between the number of times of the reuse of the sheet, the resin thickness t, the curved part R, and contamination on the back surface of the sheet. In Table 1, LV represents a level of the contamination on the back surface of the sheet. A level equal to or smaller than LV3 is a level at which the contamination on the back surface of the sheet does not matter. The larger a value of the LV is, the greater the degree of the contamination on the back surface of the sheet becomes. In Table 1, if the number of times of the reuse is 0, the normal image forming operation is executed without executing the decoloring operation. In a case in which the resin thickness t is 0 mm, the guide is formed only by the sheet metal. If the curved part R is 0 mm, the downstream end of the guide is sharp.

As shown in Table 1, if the sheet passes through the first conveyance path L1, it is found that all the levels are equal to or smaller than LV 2.5, and the level of the contamination on the back surface of the sheet is at a satisfactory level.

On the other hand, if the sheet passes through the second conveyance path L2, it is found that the number of times of the reuse, the resin thickness t, and the curved part R have a large influence on the contamination on the back surface of the sheet.

For example, in a case in which the sheet passes through the second conveyance path L2, if the resin thickness t is 1.5 mm and the curved part R is 0 mm, even if the number of times of the reuse is only one, it is confirmed that the contamination on the back surface of the sheet becomes as large as LV4.

In a case in which the sheet passes through the second conveyance path L2, if the resin thickness t is 0 mm and the curved part R is 0 mm, even if the number of times of the reuse is only one, it is confirmed that the contamination on the back surface of the sheet becomes as large as LV5.

On the other hand, in a case in which the sheet passes through the second conveyance path L2, if the resin thickness t is 0 mm and the curved part R is 1 mm, even if the number of times of the reuse is one or more, it is confirmed that the contamination on the back surface of the sheet stays at LV3 or below.

In a case in which the sheet passes through the second conveyance path L2, if the resin thickness t is 2 mm, the curved part R is 0 mm, and the number of times of the reuse is 0, it is confirmed that the contamination on the back surface of the sheet becomes as small as LV1.

Furthermore, in a case in which the sheet passes through the second conveyance path L2, if the resin thickness t is 2 mm and the curved part R is equal to or greater than 1 mm and equal to or smaller than 2 mm, even if the number of times of the reuse is one or more, it is confirmed that the contamination on the back surface of the sheet stays at LV2.5 or below.

In addition, if the sheet passes through the second conveyance path L2, if the resin thickness t is 2 mm and the curved part R is equal to or greater than 1.5 mm and equal to or smaller than 2 mm, if the number of times of the reuse is two or less, it is confirmed that the contamination on the back surface of the sheet stays at LV0.

Hereinafter, modifications are described.

The transfer section 30 is not limited to having the decoloring image forming section 34 and the non-decoloring image forming section 35. For example, the transfer section 30 may have only either one of the decoloring image forming section 34 and the non-decoloring image forming section 35.

The non-decoloring image forming section 35 is not limited to being arranged at the downstream side with respect to the decoloring image forming section 34 in the rotation direction A of the intermediate transfer belt 32. The non-decoloring image forming section 35 may be arranged at the upstream side with respect to the decoloring image forming section 34 in the rotation direction A of the intermediate transfer belt 32.

In the non-decoloring image forming section 35, it is not limited that the intermediate transfer belt 32 and the photoconductive drum 35a are in contact with each other. For example, the intermediate transfer belt 32 and the photoconductive drum 35a may be separated from each other.

The controller 101 is not limited to controlling only the decoloring image forming section 34 so that extra toner does not adhere to the intermediate transfer belt 32. For example, the controller 101 may control the non-decoloring image forming section 35 during preliminary operation such as warming-up of the non-decoloring image forming section 35.

The guide 60 is not limited to being formed by covering the sheet metal 61 with the resin member 62. For example, the guide may be formed only with resin. According to the present modification, since the guide is formed only with an insulating resin, the electric charge applied to the sheet is not disturbed and the force for keeping the toner on the sheet does not become weak, and thus it is possible to prevent dirt from gathering in the guide. Therefore, the contamination of the sheet due to the toner can be effectively prevented.

For example, the guide may be formed only by the sheet metal. For example, the sheet metal may be bent to form the curved section. According to the present modification, the rigidity of the guide can be secured by the sheet metal, and the positional accuracy of the guide can be secured. If the guide is made of only the sheet metal, a repulsion bias having the same polarity as the toner may be applied to the guide so as not to attract the toner on the sheet.

The image forming apparatus 1 is not limited to executing the printing in two modes, i.e., the monochrome toner mode and the decoloring toner mode. For example, the image forming apparatus 1 may execute the printing only in the monochrome toner mode, or may execute the printing only in the decoloring toner mode. The image forming apparatus 1 may execute the printing in the color toner mode for forming an image with non-decoloring monochrome toner and color toner. Which mode among the monochrome toner mode, the color toner mode, and the decoloring toner mode is used to execute the image formation may be selected by the user through operating the operation and display section 2 of the image forming apparatus 1.

The pair of rotating bodies is not limited to the heat roller 41 and the belt 53. For example, the pair of rotating bodies may be a fixing belt and a pressure roller.

According to the image forming apparatus of at least one embodiment described above, the contamination of the sheet due to the toner can be prevented.

The function of the image forming apparatus in an embodiment described above may be realized by a computer. In that case, it may be realized by recording a program for realizing the function in a computer-readable recording medium and enabling a computer system to read and execute the program recorded in the recording medium. The “computer system” mentioned above includes an OS or hardware such as peripheral devices. The “computer-readable recording medium” refers to a portable medium such as a flexible disk, a magneto-optical disk, a ROM, a CD-ROM and the like, or a storage device such as a hard disk built in the computer system. Furthermore, the “computer-readable recording medium” may also include a medium for dynamically holding the program for a short time, such as a communication wire for transmitting the program via a network such as an Internet or a communication line such as a telephone line, or a medium for holding the program for a certain time such as a volatile memory inside a computer system serving as a server or a client in that case. The program mentioned above may be used for realizing a part of the above-described functions, or may be used to realize the above-described function by a combination with a program already recorded in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of embodiments described herein may be made without departing from the spirit of the invention. The accompanying claims and their equivalents are intended to cover such forms or modifications as would fall within the scope and spirit of the invention.

1. An image forming apparatus, comprising:
a toner image forming section configured to form a toner image on an image carrier;
a transfer section configured to transfer the toner image onto a sheet;
a fixing section, arranged at a downstream side with respect to the transfer section in a sheet conveyance direction, and configured to fix the toner image on the sheet; and
a guide, arranged between the transfer section and the fixing section in the sheet conveyance direction, and configured to regulate the sheet conveyance direction towards the fixing section,
a controller configured to control a rotation speed of a pair of rotating bodies in such a manner that a speed at which the sheet passing through a nip formed by the pair of rotating bodies is slower than a speed at which the sheet is conveyed from the transfer section to the nip,
wherein the downstream end of the guide in the sheet conveyance direction has a shape of being curved or inclined in a direction differing from the sheet conveyance direction,
wherein the fixing section includes the pair of rotating bodies forming the nip, and
wherein the controller is configured to change a speed at which the sheet passes through the nip according to a state of the sheet or a type of a toner transferred onto the sheet.

2. (canceled)

3. The image forming apparatus according to claim 1, wherein the controller is further configured to change the speed at which the sheet passes through the nip according to a type of the sheet.

4. The image forming apparatus according to claim 1, wherein the downstream end of the guide is an arc shape with a curvature radius equal to or greater than 1 mm and equal to or smaller than 4 mm.

5. The image forming apparatus according to claim 1, wherein the guide comprises a plate-like metal member and a resin member covering the metal member.

6. The image forming apparatus according to claim 1, wherein the downstream end of the guide comprises an arcuate portion terminating in opposed planar portions, an apex of the arcuate portion being centered between the opposed planar portions.

7. A system, comprising:
a transfer section configured to transfer toner to a sheet;
a fixer configured to fix the toner on the sheet;
a controller configured to control operation of the fixer and the transfer section; and
a guide disposed between the transfer section and the fixer and oriented in a first direction, the guide being configured to direct the conveyance of the sheet to the fixer in a second direction,
wherein the guide is structured such that a curved portion of the guide diverges from the second direction,
wherein the guide comprises metal sheathed by a resin coating, and
wherein a radius of curvature of the curved portion is less than a thickness of the resin coating.

8.-10. (canceled)

11. A method, comprising:
forming a toner image on an image carrier by an image forming section;
transferring the toner image to a sheet;
fixing the toner image on the sheet, the fixing occurring at a fixing location downstream to a transfer location where transferring occurs with respect to a sheet conveyance direction, and guiding, using a guide arranged between the transfer location and the fixing location, conveyance of the sheet in the sheet conveyance direction towards the fixing location,
controlling, by a controller, a rotation speed of a pair of rotating bodies in such a manner that a speed at which the sheet passing through a nip formed by the pair of rotating bodies is slower than a speed at which the sheet is conveyed from the transfer location to the nip,
wherein a downstream end of the guide in the sheet conveyance direction has a shape of being curved or inclined in a direction differing from the sheet conveyance direction,
wherein the fixing location includes the pair of rotating bodies forming the nip, and
wherein the controller is configured to change a speed at which the sheet passes through the nip according to a state of the sheet or a type of a toner transferred onto the sheet.

12. (canceled)

13. The method according to claim 11, wherein the controller is further configured to change the speed at which the sheet passes through the portion according a type of the sheet.

14. The method of claim 11, wherein the downstream end of the guide is an arc shape with a curvature radius equal to or greater than 1 mm and equal to or smaller than 4 mm.

15. The method of claim 11, wherein the guide comprises a plate-like metal member and a resin member covering the metal member.

16. The image forming apparatus of claim 1, wherein the guide is configured to permit the sheet to move in a first conveyance path corresponding to a linear path between a sheet contact surface and the nip or in a second conveyance path which curves toward the nip.
